(19) United States
(12) Patent Application Publication
(10) Pub. No.: US 2004/0163941 A1
(43) Pub. Date: Aug. 26, 2004

(54) Method for purification of poisonous gas

(76) Inventor: Dae-Sik Yun, Seoul (KR)

Correspondence Address: BIRCH STEWART KOLASCH & BIRCH, PO BOX 747, FALLS CHURCH, VA, 22040-0747, US

(21) Appl. No.: 10/421,725

(22) Filed: Apr. 24, 2003

(30) Foreign Application Priority Data
Feb. 21, 2003 (KR) 10-2003-0010914

(51) Int. Cl. B01D 53/00

(52) U.S. Cl. 204/157.3; 423/210

(57) ABSTRACT

The present invention relates to a purification method of poisonous gas comprising spraying an aqueous solution dispersed with titanium dioxide photo-catalyst having 1 to 500 nm particle size to the poisonous gas including harmful and offensive odor generating materials and, at the same time, radiating light from a light source onto the poisonous gas to execute a photo-decomposition of the harmful and offensive odor generating materials. The purification method of the present invention can remove hydrophobic organic materials and offensive odor generating materials in improved clearance rates and has excellent applicable and economical benefits sufficient to enhance working condition of small manufacturing firms including dye works and/or processing industry.

### BACKGROUND OF THE INVENTION

1. Field of the Invention

The present invention relates to a method for purification of poisonous gas generated in dye work and/or processing applications, and more particularly to a method for purification of poisonous gas characterized in that it executes photo-decomposition of harmful and offensive odor generating materials contained in the poisonous gas by using nano-dimensional particles of titanium dioxide photo-catalyst; and, at the same time, washes and coagulates (or agglomerates) the decomposed materials by means of water spray, thereby to remove the same.

2. Description of the Related Art

As is well known in working field of manufacturing industries such as textile industry involving dye works and/or processing, excess amount of harmful and toxic gas containing poisonous materials and offensive odor generating materials are generated to cause a poor working condition and/or to damage health of workers. Consequently, it leads to refusal of on-the-spot works by applicants, especially, in the manufacturing industry occurring hazard or toxic gas in great quantities as a nature of the same, and results in lack of production labor.

Generally, “offensive odor” means a bad odor which is uncomfortable and hateful and generated from hydrogen sulfides, mercaptanes, amines and other incentive gaseous materials to stimulate sense of smell. Therefore, this becomes a sensible pollution to induce mental and/or psychological inconvenience to human as well as a harmful influence to human body.

Methods for purging or purifying the poisonous gas produced during a dye works and/or processing include, but are not limited to, combustion, adsorption, absorption and photo-decomposition procedures.

The combustion which is a process to alter combustible gas into non-colored and odorless material by burning the gas at high temperature has an advantage of high deodorization performance; however, in case of an incomplete combustion, it has also a few of disadvantages such as generation of materials bad for health, a great loss of energy involved and high cost of equipment for the combustion process.

The adsorption which is a process to remove offensive odor generating materials by using inhalation activity between molecules such as activate carbon, silica, zeolite and the like has both of a beneficial feature to efficiently eliminate organic materials including alcohol, benzene, fatty acids, mercaptanes, etc. and shortcomings of being ineffective to ammonium, amines and aldehydes and having reduced operational efficiency.

Additionally, the absorption (rinsing and removal method) is a process comprising rinsing the bad odorous components in water by using acidic and alkali chemicals and capturing and removing harmful materials and/or offensive odor generating materials. Such process is applicable to ammonia, amine, hydrogen sulfide, aldehyde, lower fatty acids and the like and can remove dust materials, whereby the process has been proposed as one of standard processes widely used for the purpose mentioned above because of its good application and economical feature. However, since the absorption process has a lack of performance for capturing hydrophobic organic solvents and reduced efficacy of removing the same, there is still a need to accomplish more sufficient clearance level of the material to be removed.

Accordingly, in recent years, studies and investigations are carried out in advance to remove volatile organic compounds usually generated in manufacturing industrial fields by way of separation manner, as well as by means of decomposition principle. In such studies, the volatile compounds are under an oxidation and decomposition process, for instance, a photo-decomposition method using TiO₂ photo-catalyst which is a representative example of conventional decomposition processes.

Since 1839, studies for photo-catalysts began by Becquerel who found that when immersing silver chloride in an electrolyte then connecting the same to a pair of electrodes, it generates voltage and electric current. Additionally, the studies for the photo-catalysts have been rapidly developed since Fujishima and Honda proposed in 1972 that water is resolved into hydrogen and oxygen if TiO₂ single crystals electrode is under radiation of light.

Titanium dioxide is well known which is stable, easily produced, and the most available compound among the photo-catalysts; which creates holes and free electrons under radiation of sunlight and/or UV light, thereby to serve as the photo-catalyst to conduct photo-decomposition of varied poisonous materials through oxidation-reduction reaction.

TiO₂ is usually in a crystal form selected from anatase and rutile and, depending on different synthetic processes, may be represented to have a combined crystal structure formed with a constant ratio of one or two structures.

There are prior arts regarding synthesis of TiO₂, for example, Korean Patent No. 350226 in which a method for preparing TiO₂ powder photo-catalyst with high specific surface area by means of homogeneous precipitation process at low temperature has been disclosed; Korean Laid-Open No. 2001-28286 in which a process for producing titanium dioxide (TiO₂) photo-catalyst having nano-dimensional particles wherein it comprises preparing an aqueous solution by adding titanium starting material in a desirable solvent, adding acidic or alkali catalyst to the aqueous solution, putting the obtained solution under heat-treatment at 80±10° C. to progress peptization of the same and to form a sol type titanium dioxide solution, and coating a substrate material with the solution to produce the resultant product has been also disclosed.

Meanwhile, there are conventional water purification methods, for example, Korean Laid-Open No. 2001-96437 disclosing a water purification pot composed of main body, assistant member coated with titanium dioxide (TiO₂) and light illumination means; and Korean Patent No. 288373 describing a dryer coated with photo-catalyst material along inside thereof.

As described above, conventionally known processes to purify water or purge poisonous gas by using titanium dioxide photo-catalyst have disadvantages that they require a complicated equipment to produce specified assistant products coated with titanium dioxide photo-catalyst over a substrate and alternative photo-radiation means in addition to the assistant product thereby to lead to a high investment cost of installation, although they have favorable purification/purging effect. Therefore, it has still a problem that smaller manufacturing companies have an economical difficulty to practically use such processes to be solved.

### SUMMARY OF THE INVENTION

It is, therefore, an object of the present invention to solve the problem described and, in particular, to provide a method for purifying and/or purging poisonous gas to efficiently clear harmful and offensive odor generating materials contained in poisonous gas by means of photo-decomposition method using photo-catalyst, and possible to economically establish production installation for the same.

More particularly, the present invention provides a method to conduct photo-decomposition of the harmful and offensive odor generating materials contained in the poisonous gas by dispersing nano-dimensional particles of titanium dioxide in an aqueous solution useable in an exiting absorption process which sprays the aqueous solution to the poisonous gas, radiating light to the poisonous gas by a number of light sources mounted within the main body of a purification apparatus, and, at the same time, by condensing and capturing the decomposed materials.

In order to accomplish the above object, there is provided a method for purification of poisonous gas comprising: spraying an aqueous solution dispersed with titanium dioxide photo-catalyst having 1 to 500 nm particle size to the poisonous gas including harmful and offensive odor generating materials, and radiating light from a light source onto the poisonous gas to execute a photo-decomposition of said harmful and offensive odor generating materials, simultaneously.

### BRIEF DESCRIPTION OF THE DRAWINGS

The above object, features and advantages of the present invention will become more apparent from the following detailed description including preferred embodiment when taken in conjunction with the accompanying drawing, in which:

FIG. 1 is a schematic flow diagram showing a purification method of poisonous gas according to a preferred embodiment of the present invention.

### DETAILED DESCRIPTION OF THE PREFERRED EMBODIMENT

Hereinafter, the configuration and operation of an embodiment according to the present invention will be described referring to the drawings.

The present invention is characterized in that it applies the photo-decomposition process using titanium dioxide photo-catalyst to an existing rinsing and removal method (that is, absorption method) which sprays water or a solution obtained by adding acidic and/or alkali chemicals in water (hereinafter referring to “the aqueous solution”) to the poisonous gas to remove the harmful and offensive odor generating materials.

More particularly, the method according to the present invention uses a specified aqueous solution dispersed with the photo-catalyst containing titanium dioxide to be sprayed over the poisonous gas, rather than using only the aqueous solution as described in the known rinsing and removal method.

Such photo-catalyst has 1 to 500 nm, more preferably 10 to 80 nm of particle size. If the particle size is above 500 nm, it is expected that the catalyst particles are agglomerated together to lead to a failure of dispersion of the particles. Furthermore, it will be understood that production cost of the titanium dioxide containing photo-catalyst becomes raised when the particle size is below 1 nm. The particle size of such photo-catalyst can be appropriately controlled in a range described above dependent on types and/or kinds of the harmful and offensive odor generating materials.

The titanium dioxide containing photo-catalyst may be produced by adding water (H₂O) in titanium tetrachloride (TiCl₄) to form titanyl chloride (TiOCl), diluting it (TiOCl) with water and allowing the diluted solution to be precipitated.

In addition, the method according to the present invention includes radiation of light from a light source 3 mounted within a main body 1 of a purification apparatus in order to activate the titanium dioxide containing photo-catalyst dispersed in the aqueous solution and injected over the poisonous gas. The light source 3 may include, but not limited to, UV ray lamp, halogen lamp, light emitting diode (LED) lamp or so on and, most preferably, UV ray lamp.

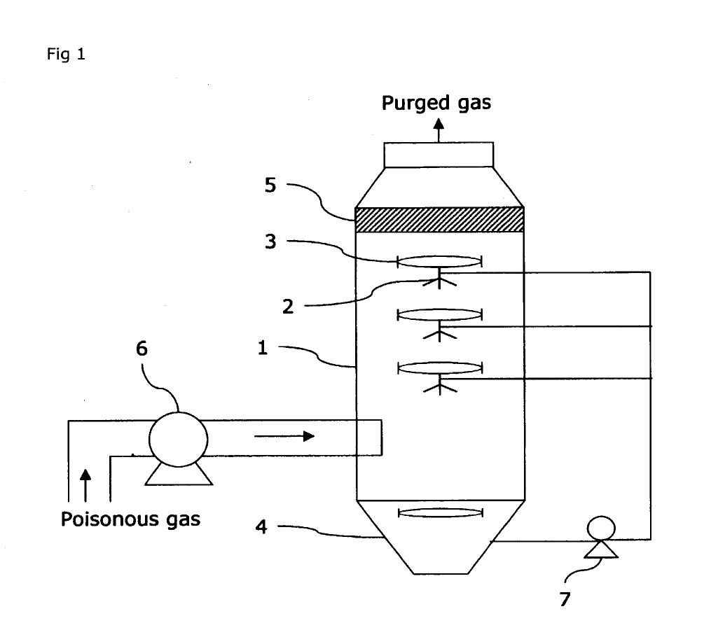

A preferred embodiment of the present invention will now be described with reference to the accompanying FIG. 1 below.

Firstly, the poisonous gas containing harmful and offensive odor generating materials passes through a fan 6 from a manufacturing place and flows into bottom side of the main body 1 of a purification apparatus.

In turns, the gas entered into the main body 1 rises toward top portion of the body 1 and, during rising, comes in contact with the aqueous solution containing the titanium dioxide photo-catalyst dispersion having nano-dimensional particles from a number of spraying devices 2 by spraying the aqueous solution over the gas.

Simultaneously, radiation of light from the light sources 3 which is mounted inside the main body 1 of the purification apparatus can promote oxidation-reduction reaction of the photo-catalyst sprayed over the gas. As a result, the harmful and offensive odor generation materials among the poisonous gas is decomposed and cleared by the photo-catalyst and, at the same time, rinsed and agglomerated by the sprayed aqueous solution thereby to be removed from the apparatus.

Such clean gas obtained after the purification method is exhausted out of the top portion of the body 1.

FIG. 1 shows the purification method according to the present invention in which the aqueous solution sprayed by means of an injection device 2 is stored in aqueous solution storage tank 4 at bottom end of the main body 1, followed by recycling to the injection device 2 through a circulation pump 7.

Consequently, as a result of measuring and/or determining respective concentrations of the harmful and offensive odor generating materials as residuals among the poisonous gas by way of atomic absorption spectroscopy after purification of such gas according to the present invention, it was clearly understood that the concentration has been lowered by 10%, compared with the harmful and offensive odor generating materials among the purged gas obtained by common rinsing and removal method using only water to be sprayed over the poisonous gas.

As described above, it will be expected that the method according to the present invention has an advantage of utilizing conventional absorption equipments for executing the absorption method previously known to induce a decrease in investment cost for establishment of the equipment; and is economically beneficial by eliminating a coating process of the titanium dioxide photo-catalyst onto a substrate.

Moreover, the method according to the present invention comprises the photo-decomposition of the harmful and offensive odor generating material among the poisonous gas and, at the same time, removes the decomposed materials by condensing and capturing such materials with the aqueous solution, whereby it can have extremely high clearance efficiency for such material.

Accordingly, the purification method of the present invention can be conveniently applicable to textile industrial fields involving dye works and/or processing, especially, small firms to manufacture the same.

What is claimed is:

1. A method for purification of poisonous gas comprising:
spraying an aqueous solution dispersed with titanium dioxide photo-catalyst having 1 to 500 nm particle size to the poisonous gas including harmful and offensive odor generating materials, and
radiating light from a light source onto the poisonous gas to execute a photo-decomposition of said harmful and offensive odor generating materials, simultaneously.

2. The method of claim 1, wherein the light source is selected from a group consisting of UV lamp, halogen lamp and LED lamp.

3. The method of claim 1, wherein the titanium dioxide photo-catalyst has a particle size ranging of 10 to 80 nm.
